(19) United States
(12) Patent Application Publication
(10) Pub. No.: US 2026/0115729 A1
(43) Pub. Date: Apr. 30, 2026

(54) SYSTEM FOR MAINTENANCE OF CRUSHER JAW OF A COMPACT ECCENTRIC CRUSHER

(71) Applicant: METSO USA INC., Brookfield, WI (US)

(72) Inventors: Guido Leuschen, Bielefeld (DE); Leon Bei der Sandwisch, Neuenkirchen (DE)

(73) Assignee: METSO USA INC., Brookfield, WI (US)

(21) Appl. No.: 18/932,867

(22) Filed: Oct. 31, 2024

(51) Int. Cl. B02C 1/02; B02C 1/08

(52) U.S. Cl. CPC B02C 1/025; B02C 1/08

(57) ABSTRACT

A compact eccentric crusher includes a system and method for moving a crusher jaw from a crushing position to a maintenance position. When the crusher jaw is in the crushing position, the first end of the crusher jaw is mounted to the crusher frame and the second end is movable to adjusting the size of the crushing gap between a crushing roller and the crusher jaw. When the crusher jaw is to be moved to the maintenance position, the second end of the crusher jaw is secured to the crusher frame and the first end of the crusher jaw pivots away from the crusher frame. To allow the pivoting movement of the first end of the crusher jaw, the connection between upper bearing assemblies and the crusher frame are removed and the upper bearing assemblies are movable with the first end of the crusher jaw.

### BACKGROUND

The present disclosure generally relates to a system for providing access to the crusher jaw of a compact eccentric crusher for maintenance. More specifically, the present disclosure relates to a mounting and pivoting arrangement for the crusher jaw of a compact eccentric crusher that allows the crusher jaw to pivot outward to a maintenance position such that wear plates on the crusher jaw can be removed and replaced from outside of the crushing chamber.

Presently, different types of crushers are being used to reduce the size of mineral material present in an infeed to the crusher. After processing, the size of the mineral material has been reduced to create a supply of the mineral material having smaller sized individual components. In these types of crushers, a moving crushing member moves toward and away from a stationary crushing member to create a varying crushing gap to crush the mineral material of the infeed.

One type of crusher used to reduce the size of mineral material is referred to as a compact eccentric crusher. In a compact eccentric crusher, a freely rotatable crushing roller is mounted to an eccentric shaft by a series of roller bearings. The crushing roller is spaced from a generally stationary crusher jaw. In the compact eccentric crusher, the eccentric arrangement of the crushing roller on the eccentric drive shaft creates eccentric movement of the crushing roller toward and away from the stationary crusher jaw. This movement varies the size of the crushing gap, which causing the mineral material fed into the compact eccentric crusher to be crushed in the crushing gap.

During operation, the freely rotatable mounting of the crushing roller on the eccentric drive shaft results in a slow rotation of the crushing roller about the eccentric drive shaft in a direction opposite to the rotation of the eccentric drive shaft. Although the crushing force is created by the lateral movement of the crushing roller relative to the stationary crusher jaw, the free rotation of the crushing roller distributes wear to all portions of the outer circumference of the crushing roller.

As the compact eccentric crusher operates to crush the mineral material, the mineral material being crushed come into contact with a wear surface formed on the stationary crusher jaw. The wear surface is typically formed by a series of wear plates that are secured to a frame of the crusher jaw. After a period of use, the series of wear plates become significantly worn and must be removed and replaced. In presently available compact eccentric roll crushers, it is difficult to remove the wear plates from the crusher jaw since maintenance personnel must be within the crushing chamber to remove the wear plates. Since the interior of the compact eccentric crusher is difficult to access, it is necessary to either remove the crusher jaw from the crusher frame or remove a number of components to provide better access to the crushing chamber. After the worn wear elements are removed, new or refurbished wear elements are then installed on the crusher jaw frame. Presently, the removal of the wear elements from the frame of the stationary crusher jaw requires the removal of a significant amount of the crusher assembly to provide access to the wear elements, making maintenance both time consuming and labor intensive.

The inventors of the present disclosure have recognized a need for an improvement in the ability to move the crusher jaw away from the crusher frame and into a maintenance position to make access to the wear elements easier and more open. In accordance with the present disclosure, the crusher jaw is moved a maintenance position. In this maintenance position, it is easier and less cumbersome to remove the wear elements from the frame of the crusher jaw. The improvement of the present disclosure moves the upper, first end of the crusher jaw away from the crusher frame during maintenance while allowing for the mounting of the first end to the crusher frame during crushing operations. Only retaining bolts at the upper end of the crusher jaw need to be removed prior to moving the crusher jaw to the maintenance position.

### SUMMARY

The present disclosure generally relates to a system and method for providing access to the crusher jaw of a compact eccentric crusher for maintenance. More specifically, the present disclosure relates to a mounting and pivoting arrangement for the crusher jaw of a compact eccentric crusher that allows the crusher jaw to pivot outward to a maintenance position such that wear plates on the crusher jaw can be removed and replaced from outside of the crushing chamber.

In accordance with one exemplary embodiment of the present disclosure, a crusher is provided that is operable to crush a supply of mineral material. The crusher includes a crusher frame that at least partially defines a crushing chamber. Within the crushing chamber, a crushing roller is mounted to a drive shaft for rotation in the crushing chamber. A crusher jaw is positioned to further define the crushing chamber. The crusher jaw is spaced from the crushing roller such that a crushing gap is formed between the crushing roller and the crusher jaw. In one exemplary embodiment, the crushing roller includes an eccentric bearing that mounts the crushing roller to a drive shaft such that the crushing roller travels along an eccentric path to crush material within the crushing gap.

The crusher jaw extends between a first end and a second end and is movable between a crushing position and a maintenance position. When the crusher jaw is in the crushing position, the first end of the crusher jaw is pivotably mounted to the crusher frame and the second end is movable into and out of the crushing chamber to adjust the size of the crushing gap between the crushing roller and the crusher jaw. When the crusher jaw is in the maintenance position, the second end of the crusher jaw is pivotably mounted to the crusher frame such that the first end of the crusher jaw is movable toward and away from the crusher frame. Movement of the first end of the crusher jaw away from the crusher frame creates a maintenance space between the crusher jaw and the frame to provide access to wear elements on the crusher jaw.

When the crusher jaw is in the crushing position, the first end of the crusher jaw is supported by a pair of upper bearing assemblies that allow for the pivoting movement of the second end of the crusher jaw to adjust the crushing gap. The pair of upper bearing assemblies are each secured to the crusher frame by one or more retaining bolts. When the retaining bolts are removed, at least a housing of the upper bearing assembly remains secured to the first end of the crusher jaw as the crusher jaw moves from the crushing position to the maintenance position.

A lower bearing assembly on the second end of the crusher jaw is secured to the crusher frame prior to movement of the crusher jaw to the maintenance position. Once the lower bearing assembly is secured to the crusher frame and the retaining bolts are removed to release the upper bearing assemblies, a maintenance cylinder is activated to move the first end of the crusher jaw away from the crusher frame to move the crusher jaw to the maintenance position.

In one exemplary embodiment, the crusher further includes a crusher jaw adjustment assembly that is operable to control the movement of the second end of the crusher jaw. The crusher jaw adjustment assembly includes a connection arm that has a first end and a second end. The first end of the connection arm is connected to the second end of the crusher jaw by the lower bearing assembly. The lower bearing assembly on the first end of the connection arm is secured to the crusher frame such that the first end of the crusher jaw can move away from the crusher frame to create the maintenance space.

In accordance with another exemplary embodiment of the present disclosure, a compact eccentric roll crusher is provided for crushing a supply of mineral material. The compact eccentric roll crusher includes a crusher frame that at least partially defines a crushing chamber. Within the crushing chamber, a crushing roller is mounted to a drive shaft for rotation in the crushing chamber. A crusher jaw is positioned to further define the crushing chamber. The crusher jaw is spaced from the crushing roller such that a crushing gap is formed between the crushing roller and the crusher jaw. The crushing roller includes an eccentric bearing that mounts the crushing roller to a drive shaft such that the crushing roller travels along an eccentric path to crush material within the crushing gap.

The crusher jaw extends between a first end and a second end and is movable between a crushing position and a maintenance position. When the crusher jaw is in the crushing position, the first end of the crusher jaw is pivotably mounted to the crusher frame and the second end is movable into and out of the crushing chamber to adjust the size of the crushing gap between the crushing roller and the crusher jaw. When the crusher jaw is in the maintenance position, the second end of the crusher jaw is pivotably mounted to the crusher frame such that the first end of the crusher jaw is movable toward and away from the crusher frame. Movement of the first end of the crusher jaw away from the crusher frame creates a maintenance space between the crusher jaw and the frame to provide access to wear elements on the crusher jaw.

The crusher further includes a pair of upper bearing assemblies that each are mounted to the crusher frame. The pair of upper bearing assemblies support the first end of the crusher jaw in the crushing position and allow the pivoting movement of the second end of the crusher jaw. Each of the upper bearing assemblies includes a housing that is secured to the crusher frame by one or more retaining bolts. When the retaining bolts are removed, the first end of the crusher jaw can be moved away from the crusher frame and into the maintenance position. When the crusher jaw is in the maintenance position, the upper bearing assembly remain connected to the first end of the crusher jaw.

In one exemplary embodiment, the compact eccentric roll crusher further includes a crusher jaw adjustment assembly that is operable to control the movement of the second end of the crusher jaw. The crusher jaw adjustment assembly includes a connection arm that has a first end and a second end. The first end of the connection arm is connected to the second end of the crusher jaw by the lower bearing assembly. The lower bearing assembly on the first end of the connection arm is secured to the crusher frame such that the first end of the crusher jaw can move away from the crusher frame to create the maintenance space. The crusher jaw assembly includes a drive unit that is operable to move the connection arm to control the position of the second end of the crusher jaw.

A method is provided to allow for maintenance on the crusher jaw of a crusher that includes a crusher frame, a crushing roller and a crusher jaw. The crusher includes a crushing gap formed between the crushing roller and the crusher jaw. In accordance with the method of an exemplary embodiment, upper bearing assemblies are proved to pivotably mount a first end of the crusher jaw to the crusher frame. The mounting of the first end of the crusher jaw allows the second end of the crusher jaw to move toward and away from the crushing roller to adjust the size of the crushing gap. When maintenance is required, the second end of the crusher jaw is secured to the crusher frame such that the second end is no longer movable. Once the second end of the crusher jaw is secured, the upper bearing assemblies are released from their mounting to the crusher frame. After the first end of the crusher jaw is releases, the crusher jaw can be moved into a maintenance position in which a maintenance space is created between the crusher jaw and the crusher frame.

In accordance with one exemplary embodiment, the second end of the crusher jaw is connected to a pair of lower bearing assemblies. When the crusher is in the maintenance position, the pair of lower bearing assemblies are secured to the crusher frame and the first end of the crusher is moved by a maintenance cylinder into the maintenance position. During this movement, the upper bearing assemblies remain mounted to the first end of the crusher jaw and thus move with the crusher jaw.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a side view showing the general operation of a compact eccentric crusher that includes a stationary crusher jaw and a movable crushing roller;

FIG. 2 is a perspective view of a compact eccentric crusher including the subject matter of the present disclosure;

FIG. 3 is a bottom perspective view of the compact eccentric crusher of the present disclosure;

FIG. 4 is a section view of the compact eccentric crusher showing the crusher jaw and crushing roller;

FIG. 5 is a side view of the compact eccentric crusher with the crusher jaw in a fully retracted position during operation of the compact eccentric crusher;

FIG. 6 is a side view of the compact eccentric crusher with the jaw adjustment assembly in the intermediate position;

FIG. 7 is a side view of the compact eccentric crusher with the jaw adjustment assembly in a fully extended position such that the crusher jaw is in position for maintenance;

FIG. 8 is a side view of the compact eccentric crusher showing removal of the retaining bolts used to secure the upper bearing housing to the crusher frame;

FIG. 9 is a side view showing the pivoting movement of the crusher jaw about the lower support shat to a maintenance position; and

FIG. 10 is a partially exploded view showing the retaining bolts used to secure the upper bearing housing.

### DETAILED DESCRIPTION

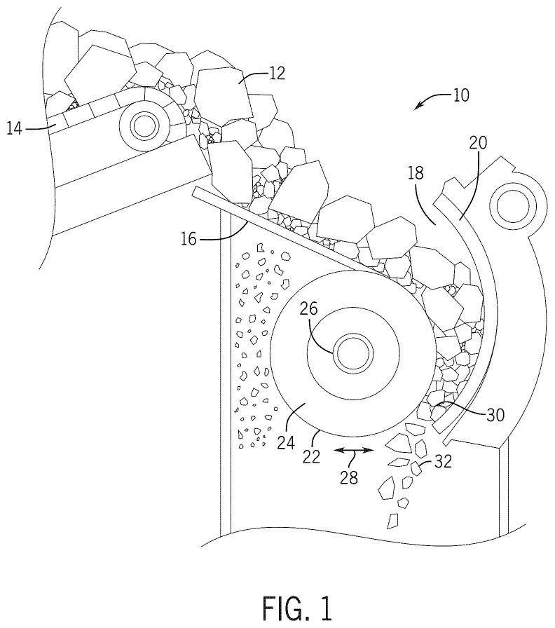

FIG. 1 generally illustrates the operation of a compact eccentric crusher 10. The compact eccentric crusher 10 shown in FIG. 1 is a representative embodiment that is included to show the general operation and configuration of a compact eccentric crusher 10 and does not limit the scope of the present disclosure since it is being included for illustrative purposes. As illustrated in FIG. 1, the compact eccentric crusher 10 receives a supply of mineral material 12 from an infeed conveyor 14. In the embodiment shown, the supply of mineral material 12 may include particles of different sizes that all fall upon an infeed screen 16 that includes slots or other openings that allow particles of a small enough size to bypass the primary crushing operation. The infeed screen 16 directs the larger particles of the supply of mineral material into a crushing chamber 18. In other contemplated embodiments, the infeed screen 16 could be eliminated such that the entire supply of material would be directed to the crushing chamber 18

The crushing chamber 18 is generally formed between the crusher jaw 20 and the outer surface 22 of the crushing roller 24. The crushing roller 24 is mounted to a drive shaft 26 that is supported by an eccentric bearing assembly that creates eccentric movement of the outer surface 22 of the crushing roller 24 along an eccentric path that includes movement toward and away from the stationary crusher jaw 20, as schematically illustrated by arrow 28. The eccentric movement of the entire crushing roller 24 toward and away from the stationary crusher jaw 20 increases and decreases the size of the crushing gap 30. During operation of the crushing roller 24, the increase and decrease in the size of the crushing gap 30 crushes the larger particles of the infeed stream to result in an outlet product flow 32.

In addition to the movement of the entire crushing roller 24, the position of the crusher jaw 20 can be modified in accordance with the present disclosure to vary the maximum and minimum size of the crushing gap 30. However, during the crushing operation, it is the eccentric movement of the crushing roller 24 relative to the stationary crusher jaw 20 that creates the crushing forces to convert the inlet product flow to the outlet product flow 32.

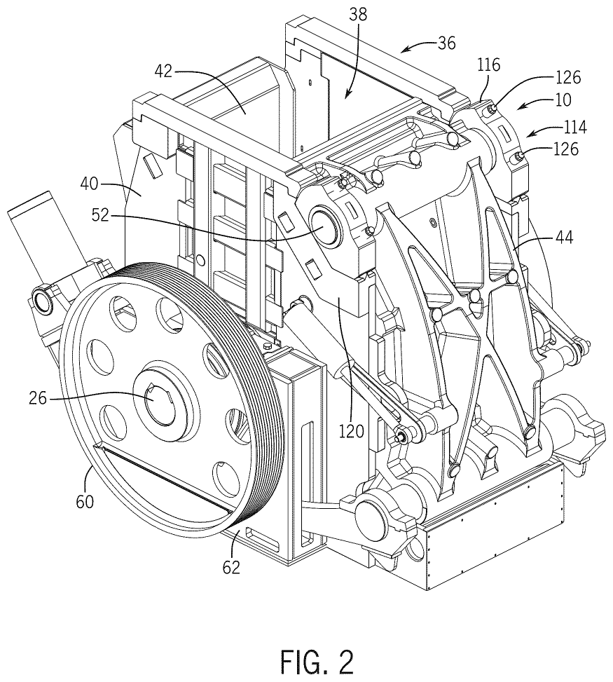

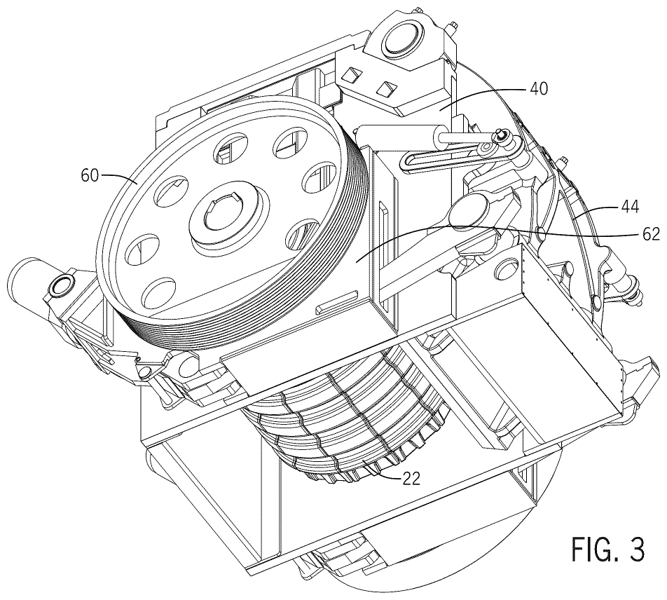

Referring now to FIGS. 2 and 3, the compact eccentric crusher 10 constructed in accordance with the present disclosure will now be further described. In the embodiment shown in FIGS. 2 and 3, the compact eccentric crusher 10 is shown as including a frame 36 that is designed to support the eccentric movement of the crusher roller and to receive a product flow at an open upper end 38 that feeds into an internal crushing chamber 18, as was schematically illustrated in FIG. 1. The frame 36 includes a pair of side walls 40 that are each spaced from each other to define a portion of the crushing chamber. A rear wall 42 further defines the crushing chamber while the crusher jaw assembly 44 defines the front portion of the crushing chamber

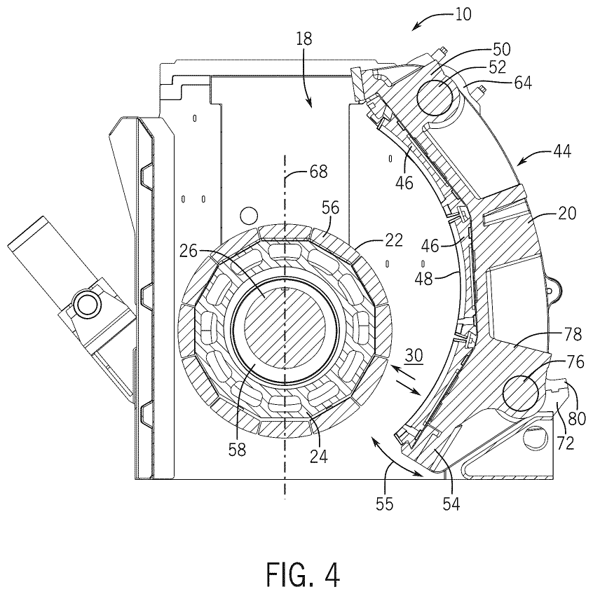

The crusher jaw assembly 44 includes the crusher jaw 20 that includes a series of wear plates 46 as best shown in FIG. 4. The wear plates 46 define a contact surface 48 for the crusher jaw 20 that is spaced from the outer surface 22 of the crushing roller 24. The spacing between the outer surface 22 of the crushing roller 24 and the contact surface 48 of the wear plates 46 creates the crushing gap 30 used to crush the mineral material fed into crushing chamber 18 of the compact eccentric crusher 10. In the embodiment shown in FIG. 4, an upper, first end 50 of the crusher jaw 20 is mounted for rotational movement about an upper support shaft 52. The lower, second end 54 of the crusher jaw 20 can be moved relative to the upper support shaft 52 to move inward and outward to adjust the size of the crushing gap 30. As indicated previously, during operation of the compact eccentric crusher 10, the crusher jaw 20 is maintained in a stationary position while the crushing roller 24 moves along an eccentric path to increase and decrease the size of the crushing gap 30 to crush the mineral material

The crushing roller 24 includes a series of wear members 56 installed on the crushing roller 24 to define the outer surface 22. During operation of the compact eccentric crusher 10, the outer surface 22 moves along an eccentric movement path and contacts the mineral material being crushed and is thus subject to wear. The individual wear members 56 can be removed from the crushing roller 24 upon sufficient wear. The crushing roller 24 is mounted to the drive shaft 26 by a series of roller bearings such that the crushing roller 24 can freely rotate relative to the drive shaft 26 during the eccentric movement of the crushing roller. During normal operation, the crushing roller 24 may not rotate or may rotate in the opposite direction as the rotation of the drive shaft 26, which evenly distributes wear to the wear members 56 installed on the crushing roller 24. The drive shaft 26 is rotatable by a drive motor or motors during operation of the compact eccentric crusher 10

As illustrated in the section view of FIG. 4, an eccentric bearing 58 is located between the crushing roller 24 and the drive shaft 26. In this manner, rotation of the drive shaft 26 creates eccentric movement of the entire crushing roller 24, thus causing the lateral movement of the crushing roller 24 toward and away from the crusher jaw 20. Such eccentric movement increases and decreases the size of the crushing gap 30 to crush the mineral material in the crushing gap 30.

Referring back to FIGS. 2 and 3, the compact eccentric crusher 10 further includes a fly wheel 60 mounted to either side of the drive shaft 26. The fly wheel 60 provides rotational mass that combines with the mass of the crushing roller during operation of the compact eccentric crusher 10. The fly wheels 60 are mounted axially outward from a bearing support structure 62 located on each side of the compact eccentric crusher 10. The bearing support structures 62 provide support for one of a pair of bearing assemblies that are used to support the crushing roller within the open crushing chamber 18 defined by the frame.

Referring now to FIG. 4, the first end 50 of the crusher jaw 20 is shown supported by the upper support shaft 52. The upper support shaft 52 passes through and is supported by a pair of upper bearing assemblies 64 on each side of the frame 36. Each upper bearing assembly 64 is located near a top end of the frame 36 of the compact eccentric crusher 10. The pivoting connection between the upper, first end 50 of the crusher jaw 20 allows the lower, second end 54 of the crusher jaw 20 to move into and out of the crushing chamber 18, as best shown by arrow 55 in FIG. 4. Such movement controls the size of the crushing gap 30.

A crusher jaw adjustment assembly 66 is positioned on both the first and second sides of the crusher frame 36 and is operable to control the movement of the second end 54 of the crusher jaw 20. Through use of the crusher jaw adjustment assemblies 66 located on each side of the crusher, the position of the crusher jaw 20 can be adjusted to control the size of the crushing gap 30 formed within the compact eccentric crusher 10. In addition, the crusher jaw adjustment assemblies 66 allow the crusher jaw to shift outward to react to an overload condition in the crushing chamber 18, such as when tramp material enters into the crushing gap 30 and cannot be crushed.

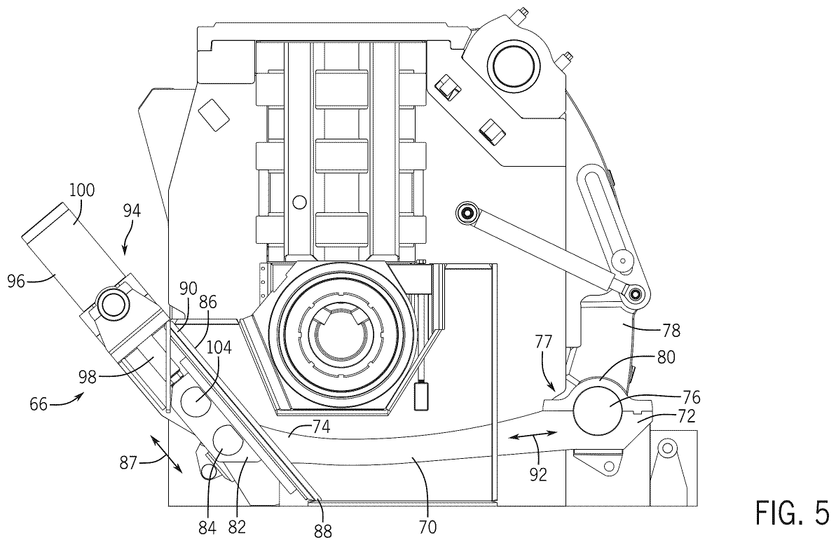

The crusher jaw adjustment assembly 66 on the side of the crusher frame shown includes a connection arm 70 that extends between a first end 72 and a second end 74. The first end 72 of the connection arm 70 is rotatably connected to the lower support shaft 76. The lower support shaft 76, as shown in the section view of FIG. 4, extends through an opening formed in the frame 78 of the crusher jaw 20 near the second end 54. As shown in FIG. 5, the lower support shaft 76 is rotatable within a lower bearing assembly 77 that is formed by the first end 72 of the connection arm 70 and a retaining bracket 80. A bearing surrounds the lower support shaft 76 such that the lower support shaft 76 can rotate relative to the lower bearing assembly 77. In this manner, the first end 72 of the connection arm 70 is connected to the frame 78 of the crusher jaw 20 while allowing the first end 72 to generally rotate in relation to the lower support shaft 76.

As shown in FIG. 5, the second end 74 of the connection arm 70 is attached to a slider 82 that forms another part of the crusher jaw adjustment assembly 66. Specifically, the second end 74 of the connection arm 70 is secured to the slider by a first pivot pin 84. The first pivot pin 84 allows for relative rotational movement between the slider 82 and the second end 74 of the connection arm 70. The slider 82 is mounted for movement along a slider rail 86 that extends from a lower end 88 to an upper end 90. The slider rail 86 includes a track that allows the slider 82 to move along a fixed longitudinal path in both a first direction and a second direction along the entire length of the slider rail 86. Since the slider 82 is connected to the second end 74 of the connection arm 70, the movement of the slider 82 in the direction shown by the arrows 87 in FIG. 5 results in movement of the slider arm in the direction shown by arrows 92. Thus, movement of the slider 82 along the slider rail 86 controls the movement of the first end 72 of the connection arm 70, and thus the second end 54 of the crusher jaw frame 78.

The crusher jaw adjustment assembly 66 further includes a drive unit 94 that is operable to move the slider 82 along the length of the slider rail. 86. In the exemplary embodiment shown in FIG. 5, the drive unit 94 is a hydraulic cylinder 96 that includes a cylinder rod 98 that can be extended and retracted relative to the cylinder body 100. As is well-known in the art, the hydraulic cylinder 96 is connected to a supply of pressurized hydraulic fluid to control the retraction and extension of the cylinder rod 98 relative to the cylinder body 100. Although a hydraulic cylinder 96 is shown in the exemplary embodiment of FIG. 5, the hydraulic cylinder 96 could be replaced by other drive units, such as but not limited to an electric motor and rotating drive screw. It is contemplated that the drive unit 94 could be any type of drive unit that is able to create the longitudinal movement of the slider 82 along the slider rail 86 as indicated by arrow 87.

In the embodiment illustrated in FIG. 5, the outer end of the cylinder rod 98 is connected to a second pin 104 that extends through another portion of the slider 82. This connection results in movement of the slider 82 in direct response to the movement of the cylinder rod 98.

As can be understood in FIG. 5, the longitudinal movement of the slider 82 in the direction shown by arrow 87 has both a vertical and horizontal component. This longitudinal movement is generally translated to the horizontal and slightly vertical movement of the connecting arm 70, as shown by arrow 92 also in FIG. 5. The movement shown by arrow 92 in FIG. 5 results in movement of the second end 54 of the crusher frame 78 into and out of the crushing chamber to adjust the size of the crushing gap 30, as is shown in FIG. 4. In this manner, operation of the drive unit 94 of the crusher jaw adjustment assembly 66 can control the position of the second end 54 of the crusher jaw 20 to thereby control the size of the crushing gap 30.

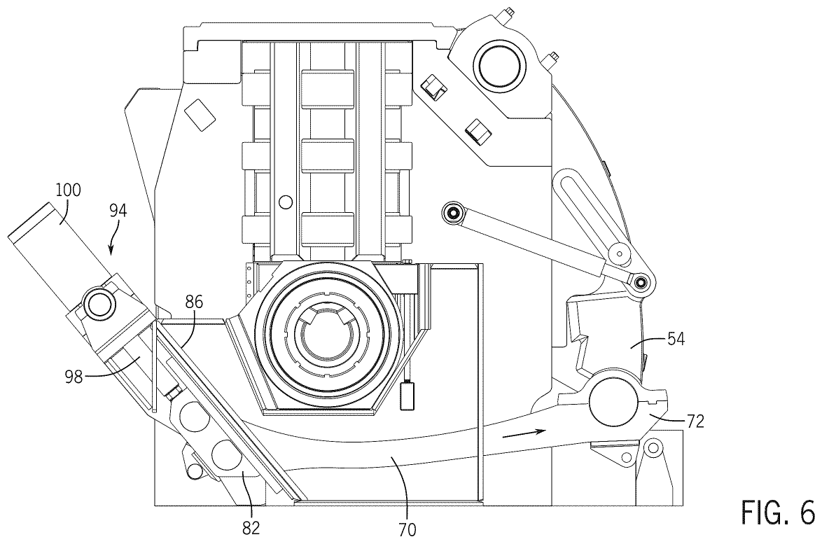

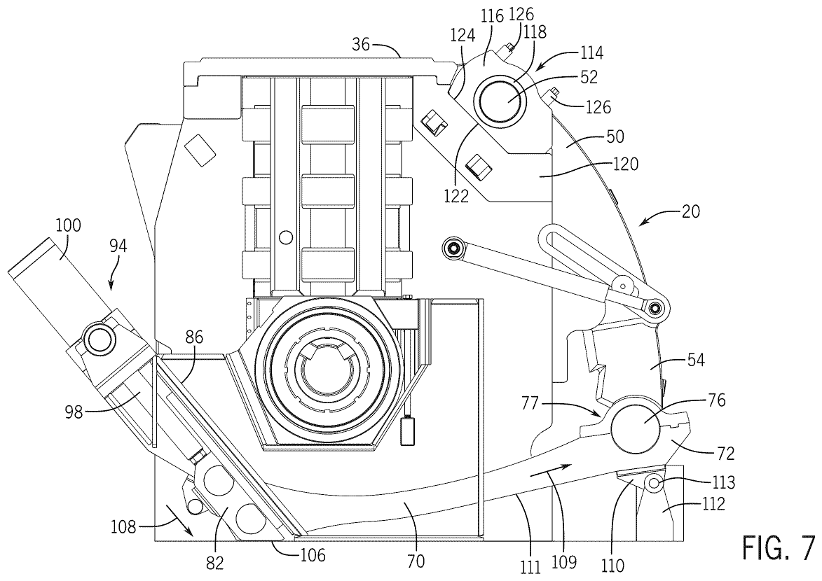

In the embodiment shown in FIG. 6, the slider 82 is shown in an intermediate position that is between a fully retracted position (FIG. 5) in which the size of the crushing gap is at a minimum and a fully extended position (FIG. 7) in which the size of the crushing gap is at a maximum. The movement of the slider 82 along the slide rail 86 by the extension of the cylinder rod 98 can thus dictate the size of the crushing gap by movement of the connecting arm 70 and the first end 72 joined to the end of the crusher jaw 20.

Referring now to FIG. 7, when maintenance for the wear plates on the crusher jaw 20 is needed, the drive unit 94 is activated, which causes the cylinder rod 98 to extend even further from the cylinder body 100, thus causing the slider 82 to move downward, as shown by arrow 108. The downward movement of the slider 82 along the slider rail 86 causes the connection arm 70 to move in the direction shown by arrow 109, thereby expanding the size of the crushing gap 30 to a maximum value.

In the fully extended position, the slider 82 is positioned adjacent to the bottom surface 106. When the slider 82 is positioned in the fully extended position shown in FIG. 7, a locking bracket 110 mounted to the bottom surface 111 of the connecting arm 70 near the first end 72 is brought into alignment with a support stand 112. When the locking bracket 110 is aligned with the support stand 112, the locking bracket 110 can be secured to the support stand 112 by the use of a locking pin (not shown) that extends through aligned openings 113. In this secured position, the lower bearing assembly 77 is held in a stationary position and the second end 54 of the crusher jaw 20 can rotate about the lower support shaft 76.

As shown in FIGS. 2 and 7, the first end 50 of the crusher jaw 20 is secured to the crusher frame 36 by a pair of upper bearing assemblies 114 that each rotatably support one end of the upper support shaft 52. The upper support shaft 52 is connected to the first end 50 of the crusher jaw 20 and is mounted for rotation within the pair of spaced bearing housings 116. The bearing housings 116 each include a bearing 118 that allows for relative pivoting and rotational movement of the upper support shaft 52 relative to the stationary bearing housing 116. Although only one of the upper bearing assemblies 114 is shown in the side view of FIG. 7, FIG. 2 illustrates that an upper bearing assembly 114 is located on each side of the crusher frame 36. In this manner, the upper support shaft 52 is supported relative to the stationary crusher frame 36 when the crusher jaw 20 is in an operating, crushing position. As can be understood in FIGS. 2 and 7, the bearing housing 116 is mounted to a bearing support block 120 which is in turn supported on one of the side walls 40 of the crusher frame 36. The bearing support block 120 includes an angled support surface 122 that engages and supports a support wall 124 of the bearing housing 116. In the embodiment shown in FIGS. 2 and 7, a pair of retaining bolts 126 extend through the bearing housing 116 to secure the bearing housing 116, and thus the entire upper bearing assembly 114, to the bearing support block 120.

During crushing operations, the upper bearing assemblies 114 are in the crushing position shown in FIG. 5. In the crushing position, the upper bearing assemblies 114 provide pivotal support for the first end 50 of the crusher jaw 20 such that the second end 54 is movable into and out of the crushing chamber to adjust the size of the crushing gap.

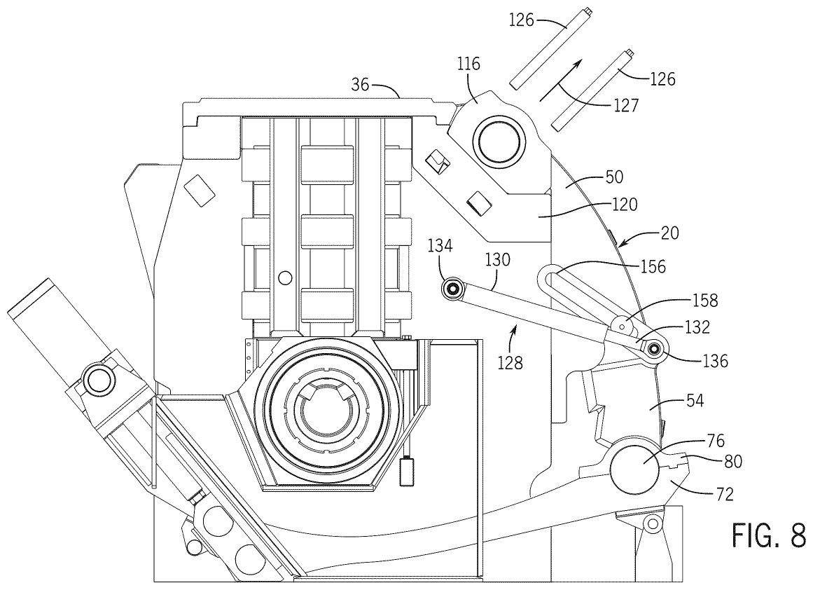

As indicated above, when maintenance is required, the lower bearing assembly 77 that is positioned on the first end 72 of the connection arm 70 is locked in place by a pin or other element that is inserted into the aligned openings 113 formed in the locking bracket 110 and support stand 112. When the lower bearing assembly 77 is locked in place, the pair of retaining bolts 126 are removed as illustrated by arrow 127 in FIG. 8. Once the retaining bolts 126 have been removed, the bearing housing 116 is released from its attachment to the bearing support block 120. In this position, the second end 54 of the crusher jaw 20 is rotatable within the lower bearing assembly 77, which in turn is fixed relative to the crusher frame 36, while the first end 50 of the crusher jaw 20 is now movable away from the crusher frame 36 since the retaining bolts 126 have been removed.

As can be understood in FIG. 8, the second end 54 of the crusher jaw 20 is supported by the lower support shaft 76 and is rotatable within the lower bearing assembly 77 as a result of a bearing positioned between the lower support shaft 76 and the first end 72 and the retaining bracket 80. Prior to the locking of the locking bracket 110 to the support stand 112, the lower bearing assembly 77 is movable with the connection arm 70.

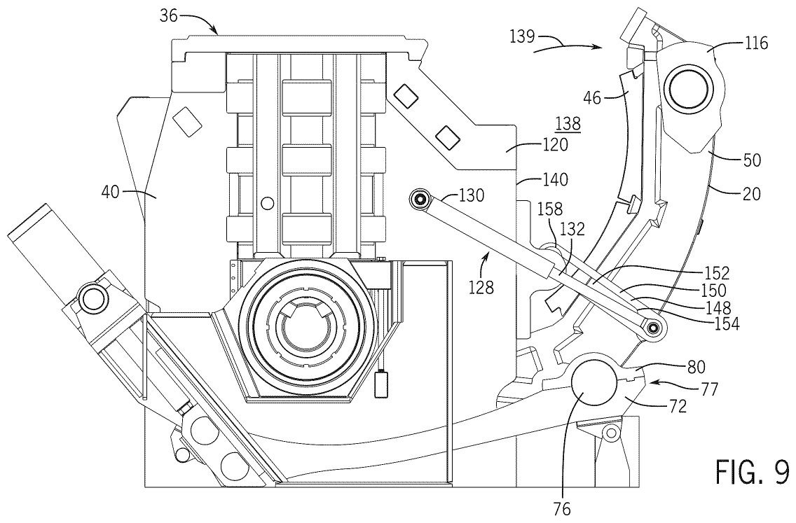

As indicated above, when maintenance is needed on the wear elements included on the crusher jaw 20, the second end 54 of the crusher jaw 20 is moved into the position shown in FIG. 8, and the retaining bolts 126 are removed. Once in this condition, a maintenance drive element, such as the maintenance cylinder 128 can be activated to move the crusher jaw 20 from the initial maintenance position shown in FIG. 8 to a second, fully opened position show in FIG. 9. The movement of the first end of the crusher jaw 20 is illustrated by arrow 139 in FIG. 9. In the exemplary embodiment shown, the maintenance cylinder 128 includes a cylinder body 130 and a cylinder rod 132. The first end 134 of the maintenance cylinder 128 is connected to the crusher frame 36 while the second end 136 is securely connected to the crusher jaw 20.

When hydraulic fluid is supplied into the cylinder body 130, the cylinder rod 132 is extended, thus causing the crusher jaw 20 to move in the direction shown by arrow 139 into the fully opened, maintenance position shown in FIG. 9. In the fully opened, maintenance position shown in FIG. 9, a maintenance space 138 is created between the first end 50 of the crusher jaw 20 and the side edge 140 of the side wall 40 of the crusher frame 36. The maintenance space 138 allows maintenance personnel to have easier access to the wear plates 46 supported on the inner surface of the crusher jaw 20. In the maintenance position shown in FIG. 9, maintenance personnel can use equipment to remove the individual wear plates 46 without having to be located within the crushing chamber. As indicated in FIG. 9, when the crusher jaw 20 is in the maintenance position, the bearing housing 116 of the upper bearing assembly remains attached to the first end 50 and is separated from the bearing support block 120.

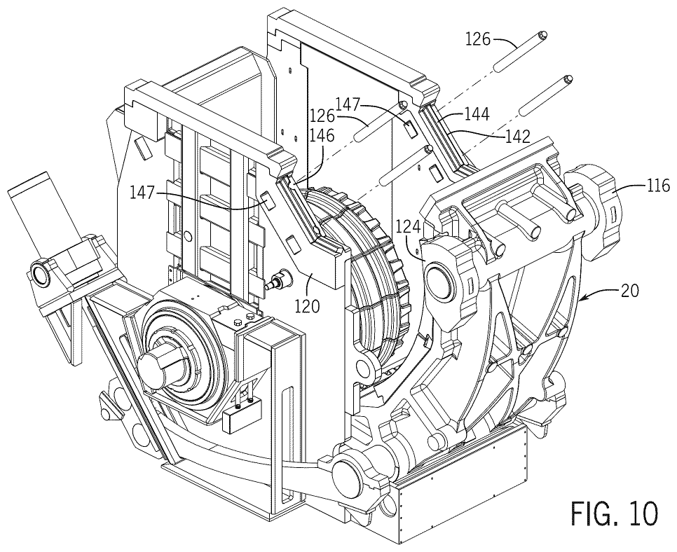

Referring now to FIG. 10, when the crusher jaw 20 is in the maintenance position, an engagement surface 142 of each of the bearing support blocks 120 is exposed. The engagement surface 142 in the exemplary embodiment illustrated includes a support ridge 144 that is designed to receive a corresponding channel formed in the support wall 124 formed on the bottom of the bearing housing 116. The interaction between the support ridge 144 and the corresponding channel formed on the bearing housing 116 restricts the lateral, axial movement of the bearing housing 116 when it is mounted such as shown in FIG. 7.

Referring back to FIG. 10, the engagement surface 142 includes a pair of access openings 146 that are each sized to receive one of the retaining bolts 126. The threaded outer end of each of the retaining bolts 126 is received within a thread block 147 that is removably received in the bearing support block 120. The removable thread blocks 147 can be removed and replaced depending upon wear or the type of retaining bolt 126 being used. In this manner, each of the retaining bolts 126 can pass through an opening formed in the bearing housing 116 and be received and retained within the thread block 147 supported by the bearing support block 122.

Referring back to FIG. 9, the maintenance cylinder 128 is shown in the fully extended position. In this fully extended position, a pivot limiting device 148 is used to define the maximum amount of rotation of the crusher jaw 20 and thus positively defines the maintenance position shown. In the embodiment shown, the pivot limiting device 148 includes a bracket 150 that includes an open slot 152 that extends from a first end 154 to a second end 156. The open slot 152 is sized to receive a pin 158 that is stationary and mounted to a portion of the crusher frame 36. During the initial movement of the crusher jaw 20 from the crushing position to the maintenance position, the pin 158 is freely movable within the open slot 152. When the crusher jaw 20 moves to its maximum, open position shown in FIG. 9, the pin 158 engages the second end 156 of the bracket 150 to prevent any further pivoting movement of the crusher jaw 20. In this manner, the pivot limiting device 148 defines the maximum pivoting movement of the crusher jaw.

After the wear elements on the crusher jaw have been replaced, the crusher jaw 20 can be moved from the maintenance position shown in FIG. 9 back to the crushing position shown in FIG. 7. Initially, the maintenance cylinder 128 is activated to retract the cylinder rod 132 to move the crusher jaw 20 from the maximum open position shown in FIG. 9 to the crushing position shown in FIG. 8. When in this position, the series of retaining bolts 126 are again used to secure each of the bearing housings 116 to the respective bearing support block 120. Once the bearing housings 116 are each again secured to one of the bearing support block 120, the pin used to secure the locking bracket 110 to the support stand 112, as shown in FIG. 7, is removed. The drive unit 94 can again be activated to move the slider 82 to adjust to the position of the crusher jaw 20 relative to the crushing roller to modify the size of the crushing gap as described previously.

Although the maintenance device is shown and described as being a maintenance cylinder 128, it should be understood that different types of mechanical components could be utilized to move the crusher jaw while operating within the scope of the present disclosure. Whatever type of maintenance device is utilized, the device must be able to generate a force to move the crusher jaw 20 between the crushing position shown in FIG. 7 and the maintenance position shown in FIG. 9.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A crusher for crushing a supply of mineral material, the crusher comprising:
a crusher frame that at least partially defines a crushing chamber;
a crushing roller mounted to a drive shaft for movement in the crushing chamber;
a crusher jaw having a first end and a second end, the crusher jaw being movable between a crushing position and a maintenance position, wherein when the crusher jaw is in the crushing position, the first end is pivotably mounted to the crusher frame and the second end is movable into and out of the crushing chamber to adjust a crushing gap between the crusher jaw and crushing roller and wherein when the crusher jaw is in the maintenance position, the second end is pivotably mounted to the crusher frame such that the first end is movable toward and away from the crusher frame.

2. The crusher of claim 1 wherein the first end of the crusher jaw is rotatably supported on the crusher frame in the crushing position by a pair of upper bearing assemblies each mounted to the crusher frame.

3. The crusher of claim 2 wherein the pair of upper bearing assemblies are secured to the crusher frame by at least one retaining bolt.

4. The crusher of claim 3 wherein the at least one retaining bolt is removed to release the upper bearing assembly and allow the crusher jaw to transition from the crushing position to the maintenance position.

5. The crusher of claim 4 wherein the pair of upper bearing assemblies remain attached to the first end of the crusher jaw and are movable with the first end of the crusher jaw when the crusher jaw moves to the maintenance position.

6. The crusher of claim 1 wherein the second end of the crusher jaw is secured to the crusher frame in the maintenance position and the first end of the crusher jaw is pivotable relative to the second end of the crusher jaw.

7. The crusher of claim 6 wherein a pair of lower bearing assemblies mount the second end of the crusher jaw to the crusher frame in the maintenance position.

8. The crusher of claim 1 further comprising a pivot limiting device connected between the crusher frame and the crusher jaw to limit the movement of the crusher jaw into the maintenance position.

9. The crusher of claim 1 further comprising:
a crusher jaw adjustment assembly positioned on first and second sides of the crusher frame, the crusher jaw adjustment assemblies being operable to control the movement of the second end of the crusher jaw, each crusher jaw adjustment assembly comprising:
a connection arm having a first end and a second end, wherein the first end is connected to the second end of the crusher jaw; and
a drive unit operable to move the connection arm to control the position of the second end of the crusher jaw.

10. The crusher of claim 9 wherein the second end of the crusher jaw is pivotably mounted to the first ends of the connection arms by a pair of lower bearing assemblies, wherein the lower bearing assemblies are fixed in a stationary position prior to movement of the crusher jaw into the maintenance position.

11. The crusher of claim 10 wherein each of the lower bearing assemblies are secured to crusher frame when the crusher jaw is in the maintenance position.

12. A compact eccentric roll crusher for crushing a supply of mineral material, the crusher comprising:
a crusher frame that at least partially defines a crushing chamber;
a crushing roller mounted to a drive shaft for movement in the crushing chamber;
a crusher jaw having a first end and a second end and movable between a crushing position and a maintenance position, wherein when the crusher jaw is in the crushing position, the first end is pivotably mounted to the crusher frame such that the second end is movable into and out of the crushing chamber to adjust a crushing gap between the crusher jaw and crushing roller and wherein when the crusher jaw is in the maintenance position, the second end is pivotably mounted to the crusher frame such that the first end is movable toward and away from the crusher frame; and
a pair of upper bearing assemblies each mounted to the crusher frame, wherein the pair of upper bearing assemblies support the first end of the crusher jaw in the crushing position and move with the first end of the crusher jaw when the crusher jaw moves into the maintenance position.

13. The compact eccentric roll crusher of claim 12 wherein the pair of upper bearing assemblies are secured to the crusher frame by at least one retaining bolt, wherein the at least one retaining bolt is removed to allow the crusher jaw to transition from the crushing position to the maintenance position.

14. The compact eccentric roll crusher of claim 12 further comprising a pair of crusher jaw adjustment assemblies being operable to control the movement of the second end of the crusher jaw, each crusher jaw adjustment assembly comprising:
a connection arm having a first end and a second end, wherein the first end is connected to the second end of the crusher jaw; and
a drive unit operable to move the connection arm to control the position of the second end of the crusher jaw.

15. The compact eccentric roll crusher of claim 14 wherein the second end of the crusher jaw is pivotably mounted to the first end of the connection arm by a pair of lower bearing assemblies, wherein the pair of lower bearing assemblies are fixed in a stationary position prior to movement of the crusher jaw into the maintenance position.

16. The compact eccentric roll crusher of claim 15 wherein each of the lower bearing assemblies are secured to the crusher frame when the crusher jaw is in the maintenance position.

17. A method of providing maintenance on a crusher jaw of a crusher having a crusher frame and a crushing roller that defines a crushing gap between the crusher jaw and the crushing roller, the method comprising the steps of:
providing upper bearing assemblies to pivotably mount a first end of the crusher jaw to the crusher frame such that the second end of the crusher jaw is movable to adjust the crushing gap;
securing the second end of the crusher jaw to the crusher frame;
releasing the upper bearing assemblies from attachment to the crusher frame; and
moving the first end of the crusher jaw away from the crusher frame into a maintenance position.

18. The method of claim 17 wherein the first end of the crusher jaw pivots relative to the second end of the crusher jaw when the second end of the crusher jaw is secured to the crusher frame.

19. The method of claim 17 further comprising the step of activating a maintenance cylinder to move the first end of the crusher jaw away from the crusher frame.

20. The method of claim 17 wherein the upper bearing assemblies move with the first end of the crusher jaw into the maintenance position.
